(19) United States
(12) Patent Application Publication
(10) Pub. No.: US 2003/0140473 A1
(43) Pub. Date: Jul. 31, 2003

(54) Dowel pin pulling machine

(76) Inventor: William Francis Marantette, Missoula, MT (US)

Correspondence Address: WILLIAM F. MARANTETTE, 2933 W CENTRAL AVE #A, MISSOULA, MT, 59804, US

(21) Appl. No.: 10/057,345

(22) Filed: Jan. 28, 2002

(51) Int. Cl. B23P 19/04

(52) U.S. Cl. 29/267

(57) ABSTRACT

A pin pulling tool which not only uses the pin pulling force to pull the pin but also uses it through a unique magnifying system of rollers and incline planes to securely close the collet. The basic tool is a hand operated tool primarily designed to pull dowel pins from tooling plates on circuit board drilling machines. This tool may have broad uses in any industry where headless pins are used and may be manual or power operated and of any size.

A “Disclosure Document Deposit Request” was filed on Feb. 1, 2001 and has the disclosure document no 488017.

This is a private “garage invented” device and no federal sponsored R & D money was involved.

The following documents and information are included in this patent application, listed in the order that they are presented.

1 Utility Patent Application Transmittal

2 Fee Transmittal forms

3 Patent Application Fee Determination Record

4 Check for Application Fee

5 Descriptive title of the invention

6 Statement Regarding Fed sponsored R & D

7 This sequence list

8 Background of Invention

9 Brief Summary of the Invention

10 Brief Description of the Drawings

11 Detailed Description

12 Claims

13 Abstract of the Disclosure

14 Drawings

15 Declaration

### BACKGROUND OF THE INVENTION

One of the important contributors to the technology of present day electronics is the technology of manufacturing circuit boards. These boards support the many types of “Chips” required to complete an electronic circuit, but more importantly the circuit boards contain all of the connecting copper ribbons required to connect the various chips electrically. Holes may be as small as 0.003 inches in diameter and the boards may be laid up with 50 layers or more of pre-etched circuits. After drilling, the holes are plated through with copper to provide the electrical paths between layers. Needless to say, the hi-tech CNC drilling machines must be extremely accurate and controlling the placement of the already etched and molded circuit boards is of great importance before drilling the thousands of tiny holes through the boards for plated-thru copper circuit connections.

When a circuit board is laid up, guide pins arranged in a particular pattern are used to align the various layers and the photo etching artwork required for etching. When the board comes to the drilling machine the boards already contain the alignment holes which will fit onto dowel pins driven into a special plastic tooling plate. This plate is bolted to the drilling machine table. The holes for the dowel pins in the tooling plate are drilled by the drilling machine as part of the same program that the circuit board will be drilled from. This reduces position errors to a minimum. When a new type of circuit board is to be drilled, the dowel pins must be pulled out so that a new configuration of dowels can be put in place for the new job.

So far all is very hi-tech. How do they pull these dowel pins? They use a forked screw driver that is bent near its end, hang onto the end of the pin with a pair of vice grips then pry out the pin. Some come out quite easily but many do not. The present invention is intended to greatly cut the manual effort, increase safety, and cut the high cost of expensive machine time while pulling obsolete dowel pins.

### BRIEF SUMMARY OF THE INVENTION

Basically, this is a hand tool which grips the pin with a conventional collet. The collet clamping is activated by roller bearings on incline planes which produce large collet-clamping forces while generating very low collet closing friction. The force required to close the collet is part of the force required to poll out the pin and it is all part of the same motion. If a pin comes out easily, it will generate only a light clamping force against the pin, thus reducing the wear on the puller parts. If the pin requires more force to pull it, the collet will automatically clamp harder to prevent slippage.

### BRIEF DESCRIPTION OF THE DRAWINGS

The accompanying drawings will be used in describing this machine.

FIG. 1 shows the part configurations in the clamping mechanism when the collet is open and ready to be placed over the pin to be pulled.

FIG. 2 shows the configurations when pulling force has been applied to the clamp #1.

FIG. 3 shows the hand lever and fulcrum arrangement which applies the pulling force to the clamping mechanism. FIGS. 1 & 2 are shown 1 ½ times size while FIG. 3 is shown ½ size.

### DETAILED DESCRIPTION

The lever 14, the fulcrum 16, and the closing pad 15 are all made of ordinary materials. In this case they are made of Aluminum alloy. The struts 13, are made of stainless steel. All of the other parts are made of hardened tool steel.

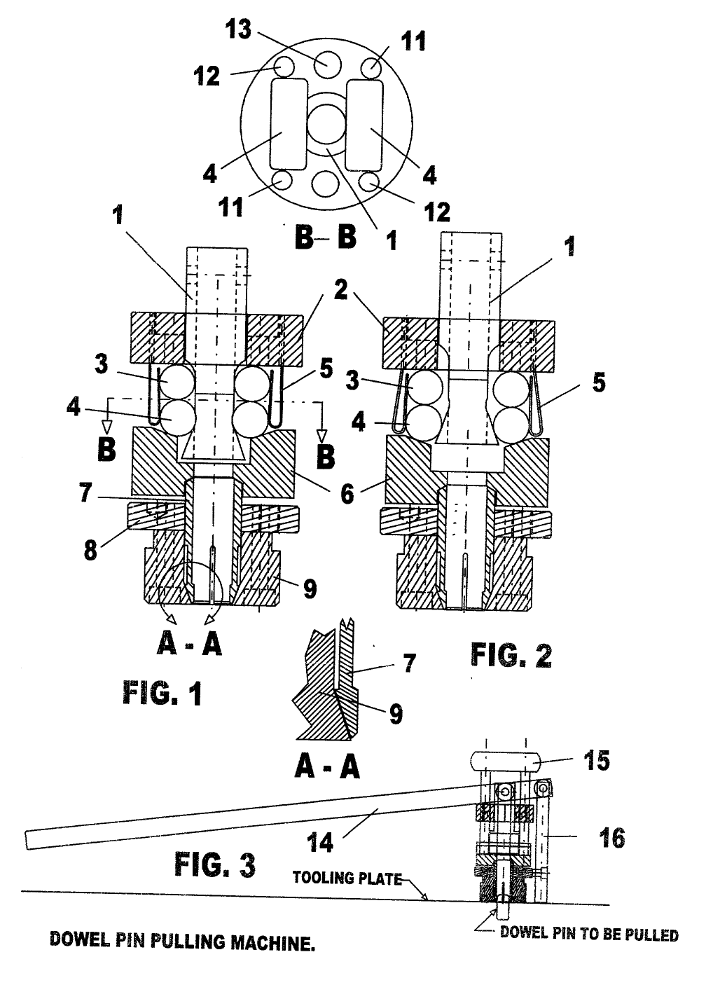

Looking at FIGS. 1, 3 and 4 are roller bearings. 2 and 8 are pulled together with two screws 11, set opposite each other. 2 and 8 are pushed apart with two screws 12 set opposite each other and placed 90 degrees from the pull screws. These four screws provide a means of adjusting the space between 2 and 8 to accommodate the various tolerances of the other parts held between them. If the spacing is too short, the collet 7 will be squeezed by the taper in 9 and will be partially closed so will not accept a dowel pin. If the spacing is too large, the collet 7, will not be close enough to be forced into the taper of 9 and it cannot close. Additionally, the pull screws are the weakest (and most available) parts of the mechanism and act as a mechanical fuse if the puller is greatly overloaded. Since the clamping power continues to increase as the required pull increases, the “fuse” provides protection for the tool. The springs 5, hold the roller bearings in place and give them a starting position that relaxes the collet allowing it to open as well as insuring that the upper and lower rollers will stay vertically aligned during the next pin pull. 8 and 9 are clamped together with four socket head cap screws. By taking out the four cap screws 9 can be removed so that a different size collet 7 can be quickly put in place to pull a different size pin without upsetting the adjustment of the rest of the tool.

To begin pulling a pin, the lever 14, is pushed down as far as possible to configure the clamping mechanism as in FIG. 1. The collet is then placed over the pin to be pulled (see FIG. 3). The other hand is used to push down on the closing pad 15, which transmits pressure through the struts 13, to the wedge 6. The wedge then transfers its pressure to the top of the collet 7. The collet moves downward into the coned cavity of the base 9, causing the collet to collapse onto the pin, that will be pulled, to provide some friction against it.

At this time the operator uses his lever hand to begin lifting the lever, 14 (FIG. 3), which is supported above the cooling plate by the fulcrum 16, and tied to the clamp 1, by pins which can swivel. As the clamp 1 (FIG. 2), is pulled up, the lower rollers are forced out and consequently roll up on the inclines of 6 until the top rollers contact the lower side of the top 2. Further upward motion on the clamp 1, causes increased downward pressure on the wedge 6 causing the collet to clamp harder. This process goes on until the upward force on the clamp 1, increases to equal the force required to pull the pin plus the amount of downward force exerted on the closing pad 15. The pin is pulled, then either drops out or escapes up through the top of the tool.

As was mentioned above, the springs 5, hold the rollers in position against the clamp 1, when the collet is open. When the clamp 1 is pulled up enough to eliminate the spacings between parts, the bottom rollers are almost directly below the upper rollers. Friction between the top rollers and the top 2, and between the upper and lower rollers keeps the top rollers approximately above the bottom rollers. The bottom rollers are locked in between the incline planes of the wedge 6, and the incline planes of the clamp 1. As the bottom rollers roll out on the wedge incline planes, they cause the top rollers to rotate in the opposite direction against the flat top. As the distance along the incline plane of the wedge 6 is nearly equal to the distance along the flat of 2, friction is always enough to keep the top rollers from slipping off the lower ones so they roll out together but rotate in opposite directions.

The unique part of this device is the way in which roller bearings are used to reduce collet closing friction to a very low value. For example, if a pin requires a 500# force to pull it, the 500# will be put on the clamp 1. After the force magnification of the rollers, the downward force exerted on the collet 7, is about 3400#. The 20 degree walls of the collet convert the 3400# downward force to nearly 10,000# against the sides of the pin to be pulled. There is friction in the cone between the collet and the side of the base 9, but the pull-out force between the pin and the collet is approximately the same as the friction in the cone so they nearly cancel each other making the collet closing process have very low friction. There is a slight additional friction factor. The pressure between the roller 4 and wedge 6 is greater than the pressure between the roller 4 and the clamp 1, so there will be no slippage between the roller 4 and wedge 6. Since the distance of travel between the roller 4, and the clamp 1, is greater than the travel of the roller against the wedge 6, there will be some sliding friction between the roller and clamp 1 as the collet tightens up, even though the motion of the two sliding surfaces is in the same direction.

Although this devise appears to have its best use in the circuit board industry with which we are most familiar, we may very well learn that its best use is in an industry in which we are not now familiar. Many manufactured parts from airplane panels to skyscraper girders have dowel pins that need to be pulled and could benefit from this puller.

What is claimed is:

1. A small hand operated pin pulling tool in which the pin pulling force also closes and locks the collet after a small energizing force signals that a collet closing is desired.

2. A tool as in claim 1 where sets of rollers operate in pairs along with incline planes to magnify the pin pulling force to an intensity that when used to close the conventional collet, the collet closing force is sufficient to prevent the collet from slipping off of the dowel pin being pulled.

3. A tool as in claim 1 which has sufficiently low friction in its collet closing mechanism to allow pins to be free to drop out of the collet once the pulling pressure is released, thus improving the efficiency of the release to save time and effort.

4. A tool as in claim 1 which makes use of the unique system of rollers and incline planes to close a collet but which derives its pull from a power system instead of manual.

5. A tool as in claim 1 and 4 which uses the clamping capabilities to act as a ratchet for pulling long rods by taking short strokes.
